(19) United States
(12) Patent Application Publication
(10) Pub. No.: US 2009/0061043 A1
(43) Pub. Date: Mar. 5, 2009

(54) Mold Insert Fixture Mechanism

(75) Inventors: Ralf Walter FISCH, Saarburg (DE); Sven Kmoch, Platten (DE)

Correspondence Address: HUSKY INJECTION MOLDING SYSTEMS, LTD;CO/AMC INTELLECTUAL PROPERTY GRP, 500 QUEEN ST. SOUTH, BOLTON, ON, L7E 5S5, CA

(73) Assignee: Husky Injection Molding Systems Ltd.

(21) Appl. No.: 11/845,173

(22) Filed: Aug. 27, 2007

(51) Int. Cl. B29C 45/36

(52) U.S. Cl. 425/577

(57) ABSTRACT

A mold insert retaining structure including a retainer plate connectable, in use, to a mold plate with a spring-clamp, a complementary bayonet structure defined on the retainer plate and a mold insert for providing a twistable interconnection therebetween, a portion of the mold insert clamped between the retainer plate and the mold plate.

### BACKGROUND OF INVENTION

1. Field of the Invention

The present invention relates, generally, to retaining a mold insert on a mold plate of an injection mold and more particularly, but not exclusively, the invention relates to a mold insert retaining structure having a spring-clamp for clamping the mold insert to the mold plate.

2. Background Information

The state of the art includes U.S. Pat. Nos. 4,911,632 issued Mar. 27, 1990 to Dana Corporation, 3,871,611 issued Mar. 18, 1975 to Phyllis Taketa, 4,556,377 issued Dec. 3, 1985 to Husky Injection Molding Systems Ltd., and 5,750,161 issued May 12, 1998 to Electra Form, Inc.

U.S. Pat. No. 4,911,632 describes a structure for releasably securing a plurality of mold inserts to a mold plate attached to a power press machine. A mold insert is inserted within an aperture by aligning the tabs with the spaces between the protrusions and moving the mold insert axially therein. Then, by rotating the mold insert relative to the mold plate, the tabs are moved over the protrusions. As a result, the mold insert is retained within the aperture. Locking bars prevent rotation of the mold inserts at undesired times to prevent them from being removed from the mold plate.

U.S. Pat. No. 3,871,611 describes an improved mold having removable and replaceable cores and cavities, so that the need of providing a new mold base for every new part or product is eliminated. The cores and cavities are tightly nested within pockets of each mold half, they are further secured therein by means of set screws.

U.S. Pat. No. 4,556,377 describes an injection mold with a female mold portion and a male mold portion has a locking ring which closely surrounds one mold portion and has a beveled inner centering surface coacting in a mold-closed position with a complementarily beveled outer centering surface of the other mold portion for properly aligning the two mold portions with each other.

U.S. Pat. No. 5,750,161 describes a mold core assembly for removable installation in a molding machine and includes a first lock element attached to a core and a second lock element movably attached to a core retainer. The second lock element is movable between a locked position fitted in locking connection with the first lock element and an unlocked position separated from the first lock element. A slip ring surrounds the first lock element of the core, engaging and holding the second lock element in its locked position. A spring is connected between the core retainer and the slip ring, with the spring biased to oppose movement of the slip ring away from its locked position so that the core is normally held in its locked position in the core retainer.

FIG. 1 is a cross-sectional view of a portion of an injection mold that depicts a section through a mold insert assembly that defines a molding cavity for the production of preforms of the type that are blow molded into bottles and the like. The injection mold is illustrated in a mold closed position. The mold insert assembly includes a core insert 12, a cavity insert 14, a gate insert 20, a split mold insert 16, and a lock ring insert 30 that cooperate to define the molding cavity.

The cavity insert 14 and gate insert 20 each include molding surfaces that define portions of the molding cavity that correspond to an outer body portion and an end portion of the preform 2, respectively. The gate insert 20 defines an interface 23 for cooperation with a nozzle assembly (not shown) of a melt distribution system (not shown), the gate insert 20 also defines a melt channel to allow, in use, molten plastic to be injected from the nozzle assembly and into the molding cavity. The cavity insert 14 and the gate insert 20 are arranged in a cavity plate 15. Cooling channels 21 are defined in the cavity plate 15 that cooperate with cooling channels defined on the cavity insert 14 and the gate insert 20 for circulation, in use, of a coolant.

The core insert 12 and the lock ring insert 30 each include molding surfaces that define portions of the molding cavity that correspond to an inner body portion and a top portion, in part, of the preform 2, respectively. The core insert 12 and lock ring insert 30 are mounted to a face of a core plate 13. More particularly, the lock ring insert 30 is bolted to the face of the core plate 13 by bolts 17 (only one shown), the lock ring insert 30 surrounding the core insert 12 with a taper interface 31 defined therebetween for clamping the core insert 12 to the core plate 13. A cooling tube 22 extends from the core plate 13 and into a bore 26 defined within the core insert 12. The cooling tube 22 and the channel 26 cooperate to define a channel that extends between cooling channels 24, 25 defined in the core plate 13 for circulation, in use, of a coolant.

The split mold insert 16 includes a molding surface that defines a portion of the molding cavity that correspond to a neck finish portion of the preform 2. The split mold insert 16 includes a complementary pair of split mold halves 16a and 16b that can be positioned laterally between an engaged and a disengaged position with respect to the other mold inserts of the mold insert assembly, and in any case perpendicular to a longitudinal axis of the core insert 12. The split mold halves 16a and 16b are mounted to a connecting structure for the repositioning thereof between the engage and disengaged positions. The connecting structure includes a pair of slides 36a and 36b that are supported on a stripper plate 32 by a wear plate 34. Each neck ring half 16a and 16b is secured to a respective one of the slides 36a and 36b. The connecting structure also includes an actuator (not shown), typically a cam and cam follower arrangement, for repositioning, in use, the slides 36a and 36b, and with them the split mold halves 16a and 16b. Cooling channels 39 are defined in the slides 36a and 36b that cooperate with cooling channels defined in the split mold halves 16a and 16b for circulation, in use, of a coolant.

In operation of the injection mold the replacement of one or more of the mold inserts of the mold insert assembly is common place. In the foregoing example, the replacement of the core insert 12 on the core plate 13, for example, requires undoing the bolts 17 and removing the lock ring 30. This is time consuming and labor intensive activity.

### SUMMARY OF INVENTION

In accordance with a first aspect of the present invention a mold insert retaining structure is provided for quick removal and replacement of a mold insert on a mold plate of an injection mold. The mold insert retaining structure includes a retainer plate connectable, in use, to a mold plate with a spring-clamp, a first bayonet structure defined on the retainer plate and a second bayonet structure associated with the mold insert, the first bayonet structure and the second bayonet structure configured to cooperate for providing, in use, a twistable interconnection therebetween, the first bayonet structure and the second bayonet structure may be arranged between a clamped position wherein the second bayonet structure is clamped between the first bayonet structure and the mold plate, and an unclamped position wherein the first bayonet structure is disengaged from the second bayonet structure.

In accordance with a second aspect of the present invention a mold insert is provided for quick removal and replacement on a mold plate of an injection mold having a mold insert retaining structure. The mold insert includes a body having a molding surface that defines a portion of a molding cavity in cooperation with other mold inserts of a mold insert assembly. A second bayonet structure associated with the body, the second bayonet structure configured to cooperate with a first bayonet structure defined on a first retainer plate of the mold insert retaining structure for providing a twistable interconnection therebetween. The retainer plate connected, in use, to the mold plate with a spring-clamp. The first bayonet structure and the second bayonet structure may be arranged between a clamped position wherein the second bayonet structure is clamped between the first bayonet structure and the mold plate, and an unclamped position wherein the first bayonet structure is disengaged from the second bayonet structure.

In accordance with a third aspect of the present invention an injection mold is provided that includes the mold insert retaining structure and mold insert in accordance with the first and second aspects of the present invention, respectively.

### BRIEF DESCRIPTION OF DRAWINGS

A better understanding of the embodiments of the present invention (including alternatives and/or variations thereof) may be obtained with reference to the detailed description of the embodiments along with the following drawings, in which:

FIG. 1 is a cross-sectional view of a portion of a known injection mold taken through a mold insert assembly that defines a molding cavity for forming preforms;

FIG. 2 is a plan view of a portion of a mold plate assembly of an injection mold in accordance with a non-limiting embodiment of the present invention.

FIG. 3 is a cross-sectional view taken along the section line 3-3 in FIG. 2;

FIG. 4 is an enlarged sectional view of an encircled portion designated at 4-4 identified in FIG. 3 that depicts a mold insert retaining structure retaining a mold insert to a mold plate of the mold plate assembly;

FIG. 5 is an exploded view of the mold insert retaining structure and mold insert of FIG. 3.

### DETAILED DESCRIPTION

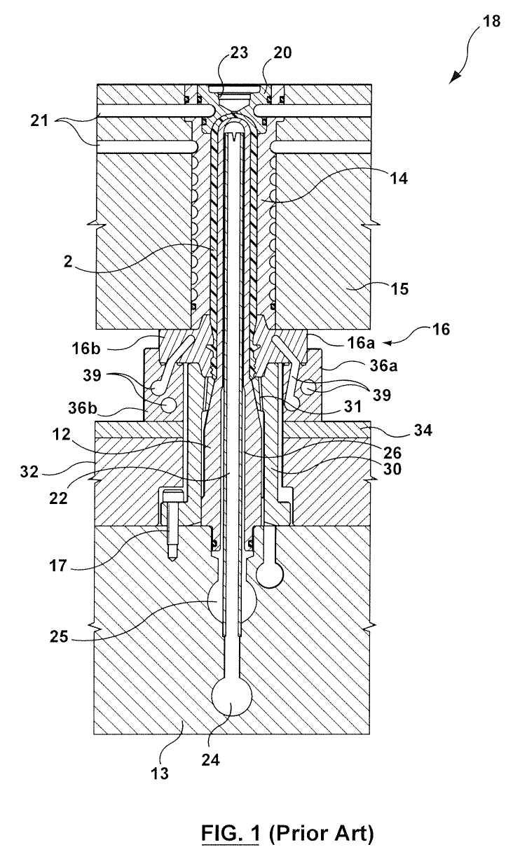

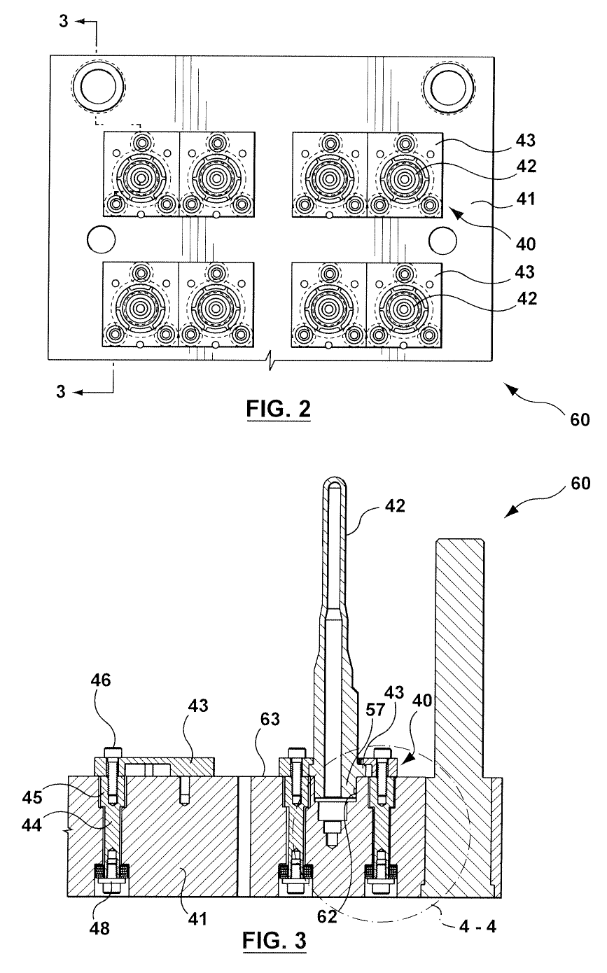

Referring to FIG. 2, a portion of a mold plate assembly 60 in accordance with a non-limiting embodiment of the present invention is shown. The mold plate assembly 60 may be used with the injection mold 18 described previously and shown with reference to FIG. 1. The portion of the mold plate assembly 60 includes a mold plate 41 with eight mold inserts 42 retained thereon by a corresponding plurality of mold insert retaining structures 40. Other configurations of the mold plate assembly are, of course, possible such as, for example, different quantities of the mold inserts 42 and corresponding mold insert retaining structures 40. Each of the mold insert retaining structures 40 is shown as including a retainer plate 43 holding a corresponding one of the mold inserts 42 to the mold plate 41. The retention of the mold inserts 42 on the mold plate 41 will be described in more detail hereinafter with reference to FIGS. 3, 4 and 5.

In the non-limiting embodiment the mold insert 42 is configured similarly to the core insert 12 described previously for the purpose of molding the inner body portion of the preform 2. Alternatively, the mold insert 42 may be configured similarly to other mold inserts of the mold insert assembly to mold other portions of the preform 2, such as, for example, cavity insert 14 for molding the outer body portion of the preform 2.

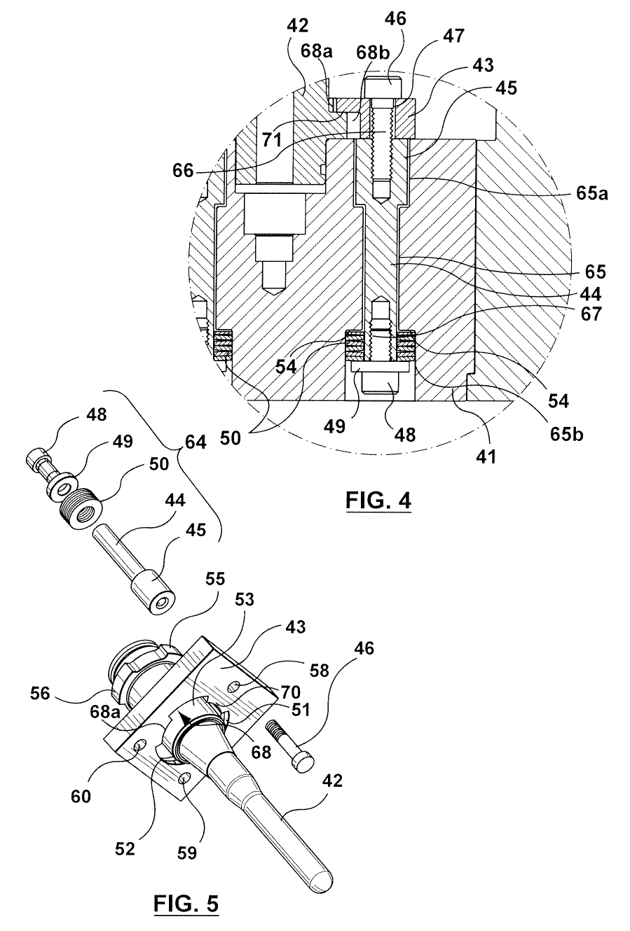

FIG. 3 is a sectional view of the mold plate assembly 60 taken along the sectional line 3-3 of FIG. 2. The mold inserts 42 are positioned on a face 63 of the mold plate 41 with a spigot portion 57 thereof received in a complementary bore 62 formed in the mold plate 41. The interface between the spigot portion 57 and the complementary bore 62 may be close fitting such that the mold insert 42 is closely positioned for alignment with the other mold inserts of the mold insert assembly. Each mold insert 42 is retained on the mold plate 41 with the assistance of a clamping pressure exerted by the retainer plate 43 of the mold insert retaining structure 40. More particularly, each of the mold insert retaining structures 40 further includes a plurality of spring-clamps 64 coupling the retainer plate 43 to the mold plate 41 and urges the retainer plate 43 towards the face 63 of the mold plate 41. In the non-limiting embodiment three of the spring-clamps 64 are equi-angularly arranged around each mold insert 42, however, any reasonable number of mold insert retaining structures 40 could be used. A non-limiting embodiment of the spring-clamp 64 is shown in more detail in FIGS. 4 and 5. Each spring-clamp 64 of the non-limiting embodiment is an assembly that includes a pin 44, a spring 50, a first fastener 46, a second fastener 48, and a washer 49. The pin 44 is a cylindrical member having a outwardly projecting head 45 at an end thereof. Each pin 44 is slidably received in a pin bore 65 that passes through the mold plate 41. The pin bore 65 includes a first counter-bore portion 65a at an end thereof for receiving the head 45 of the pin 44. Each pin 44 includes a first coupler 66 formed in the head 45 thereof and a second coupler 67 formed at the opposite end of the pin 44 from the head 45. The first coupler 66 and the second coupler 67 cooperate, in use, with the first and second fasteners 46, 48, respectively. Each retainer plate 43 includes three fastener bores 58, 69, and 60 formed therethrough that cooperate with the corresponding first fastener 46 of the three spring-clamps 64 associated with each mold insert 42. Each pin bore 65 also includes a second counter-bore 65b at another end thereof (opposite end of the pin bore 65 from the first counter-bore portion 65a). The spring 50 is arranged in the second counter-bore portion 65b sandwiched between a face 54 of the second counter-bore portion 65b and the washer 49, the washer 49 fastened to the end of the pin 44 between the second fastener 48 and the second coupler 67. The springs 50 are placed into a pre-compressed condition by engaging the second fastener 48 with the second coupler, such as, for example, the tightening of a screw fastener into a complementary threaded bore, respectively. In the pre-compressed condition the compressed spring 50 retains sufficient remaining resiliency that the retainer plate 43 may be lifted slightly for sake of effecting a removal and/or installation of the mold insert 42. It has been found that with only a minimal flexibility remaining in the spring 50 in the pre-compressed condition that the mold insert 42 remains better aligned with the cavity insert 14 than was previously possible with the more rigid core insert 12 mounting shown in the prior art design illustrated in FIG. 1.

Each retainer plate 43 is a substantially rectangular plate with the fastener bores 58, 59 and 60 equi-angularly arranged and a central bore 68. The central bore 68 extends through a top and bottom face of the retainer plate 43. The central bore includes an upper portion 68a having an inner surface that surrounds, in use, a portion of the mold insert 42, the inner surface having a diameter that is the same as, or slightly larger than, the diameter of the portion of the mold insert 42 adjacent thereto. The upper portion 68a of the central bore 68 having a first irregular outline defining three arcuate cut-out portions 51, 52 and 53 formed in an equi-angularly spaced relation through the inner surface of the upper portion 68a through which fingers 55 and 56 of the mold insert 42 may be passed. A plurality of webs 70 span between the cut-out portions 51, 52, and 53. The central bore includes a lower portion 68b beneath the webs 70 having a diameter that is at least as wide as a maximum diameter of the fingers 55 and 56 of the mold insert 42.

Each mold insert 42 includes a body with three arcuate fingers 55 and 56 (shown with one hidden in FIG. 5) projecting from a base portion thereof. The fingers 55 and 56 of the mold insert 42 are complementary to the cut-out portions 51, 52 and 53 of the retainer plate 43 in shape and angular position. To install the mold insert 42 onto the mold plate 41, the fingers 55 and 56 are to be aligned and passed through the cut-out portions 51, 52, and 53 of the retainer plate 43 and into the space defined by the lower portion 68b of the central bore 68. Thereafter, the mold insert 42 is rotated to pass the fingers 55 and 56 beneath webs 70 of the retainer plate 43 that span between the cut-out portions 51, 52, and 53 whereupon the fingers 55 and 56 of the mold insert 42 are clamped between corresponding bottom surfaces 71 of the webs 70 and the face 63 of the mold plate 41. To ease the engagement of the fingers 55 and 56 beneath the webs 70 of the retainer plate 43, a relief on a portion of a top surface of the fingers 55 and 56 and/or on the bottom surfaces 71 of the webs 70 may be provided. Alternatively, a pry slot or other lifting means may be provided to momentarily lift the retainer plate 43 from the face 63 of the mold plate 41 to effect the rotation of the mold insert 42. To remove the mold insert 42 from the mold plate 41 is the reverse of the steps of installation thereof.

Hence, the mold insert retaining structure 40 permits the mold insert 42 to rotate between an unclamped position wherein the fingers 55 and 56 and the cut-out portions 51, 52, and 53 are aligned and the mold insert 42 is not retained to the mold plate 41, and a clamped position where the fingers 55 and 56 are arranged in the lower portion 68b of the central bore 68 and are aligned with the plurality of webs 70 wherein the fingers 55 and 56 of the mold insert 42 are clamped between a plurality of bottom surfaces 71 of the plurality of webs 70 and the face 63 of the mold plate 41. When it is necessary to change a mold insert 42, hand pressure on the mold insert 42 against the pressure of springs 50 is generally sufficient to permit rotation of the mold insert 42 to a position where the fingers 55 and 56 and the one hidden are aligned with the cut-out portions 51, 52 and 53 in the retainer plate. The mold insert 42 can then be withdrawn from the mold plate 41. In like manner, a replacement mold insert 42 can be readily mounted on the mold plate 41 by simply aligning its fingers 55 and 56 with the cut-out portions 51, 52 and 53 on the retainer plate 43 and inserting and rotating the replacement mold insert 42 into the position vacated by the earlier mold insert 42.

More particularly, the spring 50 permits the retainer plate 43 to be lifted by twisting action of the mold insert 42. As a practical matter, when the mold insert 42 is removed, the spring 50 draws the retainer plate 43 into contact with the mold plate 41. However, when the mold insert 42 is in place, the retainer plate 43 is slightly lifted by the action of engaging the mold insert 42 and a small gap exists between the retainer plate 43 and the mold plate 41.

In the embodiment shown in FIG. 5, the cut-out portions 51, 52 and 53 and the fingers 55 and 56 are complementary and of equal arcuate length and form a bayonet structure that can, through twisting of the mold insert 42 alone, permit insertion and removal of the mold insert 42.

For example, the fingers 55 and 56 could be of very short arcuate length and the cut-out portions 51, 52 and 53 could be any arcuate length greater than the arcuate length of the fingers 55 and 56. Also, the fingers 55 and 56 and cut-out portions 51, 52, and 53 could be of different shapes, the only requirement being that the fingers 55 and 56 on the mold insert 42 be able to pass through the cut-out portions 51, 52, and 53 on the retainer plate 43. Also the number of cut-outs and fingers could something other than three as shown in our preferred embodiment. The shape, size, number and location of the fingers 55 and 56 and cut-out portions 51, 52, and 53 may be largely determined by such factors as cost and ease of manufacture and the part strength necessary to withstand the rigors of injection molding.

It will, of course, be understood that the above description has been given by way of example only and that modifications in detail may be made within the scope of the present invention.

What is claimed is:

1. A mold insert retaining structure for quick removal and replacement of a mold insert on a mold plate of an injection mold, the mold insert retaining structure comprising:
a retainer plate connectable, in use, to the mold plate with a spring-clamp, a first bayonet structure defined on the retainer plate and a second bayonet structure associated with the mold insert, the first bayonet structure and the second bayonet structure configured to cooperate for providing a twistable interconnection therebetween, the first bayonet structure and the second bayonet structure may be arranged between a clamped position wherein the second bayonet structure is clamped between the first bayonet structure and the mold plate, and an unclamped position wherein the first bayonet structure is disengaged from the second bayonet structure.

2. The mold insert retaining structure of claim 1, wherein:
the retainer plate is configured for retaining, in use, the mold insert on the mold plate, the retainer plate having a central bore for receiving the mold insert;
the central bore having:
an upper portion having an inner surface that surrounds, in use, a portion of the mold insert, the upper portion having a first irregular outline defining a plurality of cut-out portion through which the second bayonet structure of the mold insert may be passed, the first bayonet structure includes a plurality of webs that span between the plurality of cut-out portions, the second bayonet structure includes fingers projecting from the mold insert;
a lower portion beneath the webs having a diameter that is at least as wide as a maximum diameter of the fingers of the mold insert;
the spring-clamp for coupling, in use, the retainer plate to the mold plate and urges the retainer plate against a face of the mold plate;
mold insert retaining structure permitting the mold insert to rotate between an unclamped position wherein the fingers and the cut-out portions are aligned and the mold insert is not retained to the mold plate, and a clamped position where the fingers are arranged in the lower portion of the central bore and are aligned with the plurality of webs wherein fingers of the mold insert are clamped between a plurality of bottom surfaces of the plurality of webs and the face of the mold plate.

3. The mold insert retaining structure of claim 2, wherein:
the spring-clamp 64 includes a pin slidably received, in use, in a pin bore that passes through the mold plate.

4. The mold insert retaining structure of claim 3, wherein:
the pin includes an outwardly projecting head at an end thereof, the pin bore includes a first counter-bore portion at an end thereof for receiving the outwardly projecting head of the pin.

5. The mold insert retaining structure of claim 4, wherein:
the pin includes a first coupler formed in the outwardly projecting head, the first coupler cooperates, in use, with a first fastener 46.

6. The mold insert retaining structure of claim 5, wherein:
the retainer plate includes a fastener bore formed therethrough that cooperate with the first fastener of the spring-clamp.

7. The mold insert retaining structure of claim 5, wherein:
the pin includes a second coupler formed at an opposite end of the pin from the outwardly projecting head, the second coupler cooperates, in use, with a second fastener.

8. The mold insert retaining structure of claim 7, wherein:
the pin bore also includes a second counter-bore at an opposite end of the pin bore from the first counter-bore portion.

9. The mold insert retaining structure of claim 8, wherein:
a spring is arranged in the second counter-bore portion sandwiched between a face of the second counter-bore portion and a washer, the washer fastened to the end of the pin between the second fastener and the second coupler.

10. The mold insert retaining structure of claim 9, wherein:
the spring is placed into a pre-compressed condition by engaging the second fastener with the second coupler.

11. The mold insert retaining structure of claim 2, wherein:
a relief is provided on a portion of a top surface of the fingers.

12. The mold insert retaining structure of claim 2, wherein:
a relief is provided on a bottom surfaces of the webs.

13. The mold insert retaining structure of claim 2, wherein:
the retainer plate includes a lifting means to momentarily lift the retainer plate from the face of the mold plate to effect the rotation of the mold insert.

14. The mold insert retaining structure of claim 2, wherein:
a plurality of the spring-clamps are equi-angularly arranged around each location of a mold insert.

15. A mold insert for quick removal and replacement on a mold plate of an injection mold having a mold insert retaining structure, the mold insert comprising:
a body having a molding surface that defines a portion of a molding cavity in cooperation with other mold inserts of a mold insert assembly;
a second bayonet structure associated with the body, the second bayonet structure configured to cooperate with a first bayonet structure defined on a first retainer plate of the mold insert retaining structure for providing a twistable interconnection therebetween, the retainer plate connected, in use, to the mold plate with a spring-clamp;
the first bayonet structure and the second bayonet structure may be arranged between a clamped position wherein the second bayonet structure is clamped between the first bayonet structure and the mold plate, and an unclamped position wherein the first bayonet structure is disengaged from the second bayonet structure.

16. The mold insert of claim 15, wherein:
the second bayonet structure includes a plurality of arcuate fingers projecting from a base portion of the body.

17. The mold insert of claim 15, wherein:
the fingers of the mold insert are complementary to a plurality of cut-out portions formed in the retainer plate 43.

18. The mold insert of claim 15, wherein:
the body includes a spigot portion that is received, in use, in a complementary bore 62 formed in the mold plate 41.

19. An injection mold including the insert retaining structure and mold insert of any one of claims 1, 2, 3, 4, 5, 6, 7, 8, 8, 10, 11, 12, 13, 14, 15, 16, 17, or 18.
